(19) United States
(12) Patent Application Publication
(10) Pub. No.: US 2015/0233026 A1
(43) Pub. Date: Aug. 20, 2015

(54) Thermoplastic-Poly(Dihydrocarbylsiloxane) Compositions, and Fibers, and Processes for Making Fibers

(71) Applicants: Mansour K. ABDULBAKI, Columbia, SC (US); Franklin P. WILLIAMS, III, (US); INVISTA North America S.a.r.l., Wilmington (DE)

(72) Inventors: Mansour K. Abdulbaki, Columbia, SC (US); Franklin P. Williams, III, Camden, SC (US)

(73) Assignee: INVISTA NORTH AMERICA S.A.R.L., Wilmington (DE)

(21) Appl. No.: 14/429,237

(22) PCT Filed: Oct. 18, 2013
(86) PCT No.: PCT/US2013/065643

§ 371 Date: Mar. 18, 2015

Related U.S. Application Data
(60) Provisional application No. 61/716,070, filed on Oct. 19, 2012.

(51) Int. Cl. D02G 3/04; D01F 1/06; D06N 7/00; C08L 77/06; C08L 77/02; C08L 67/02

(52) U.S. Cl. CPC D02G 3/045; C08L 77/02; C08L 67/02; D06N 7/0065; C08L 77/06; D01F 1/06; D06N 2201/0263; D06N 2201/02; D10B 2331/02; D10B 2331/04; D10B 2331/30; D10B 2401/14

(57) ABSTRACT

Polymer compositions useful as shaped articles such as synthetic yarns are disclosed. The polymer compositions include poly(dihydrocarbylsiloxane) components featuring one or more of octyl, dodecyl, cetyl, behenyl, vinyl, bis-vinyl, vinyl-reacted, or bis-vinyl-reacted substituents. The synthetic yams have been used to produce tufted carpets having improved performance characteristics, including softness benefits, as well as improved water repellency and soil release.

### FIELD OF THE INVENTION

The invention relates to compositions of thermoplastics and poly(dihydrocarbylsiloxane)s, and fibers and carpets formed therefrom. Fibers prepared from the polymer compositions have improved softness and water repellency and soil release characteristics relative to parent thermoplastic fibers. The thermoplastics and poly(dihydrocarbylsiloxane)s are combined by extrusion and can be pelletized or spun into fibers. The as-produced fibers have been tufted into carpet and are found to give substantial improvements in softness, water repellency and soil release characteristics.

### BACKGROUND OF THE TECHNOLOGY

Synthetic fibers are very frequently treated with topical protectants for improvement of desirable attributes such as, for example, softness, oil repellency, water repellency, durability, light fastness, dirt repellency and stain resistance. For example, synthetic fibers are known to require what are termed “secondary finish” chemistries in order to improve their performance and meet consumer expectations. Such finishes are termed “secondary,” as primary finish chemistries are used to facilitate upstream fiber spinning processes. Examples of secondary finish chemistries for application onto synthetic fiber are found in U.S. Pat. No. 6,790,905 to Fitzgerald, et al, which describes water-borne fiber protectant compositions for carpets.

However, the processes used to apply such secondary, or topical chemistries can be energy intensive, time intensive, resource intensive, and operationally complex. For example, the processes disclosed in U.S. Pat. No. 5,851,595 ('595, to Jones), require complex machinery in order to combine what are otherwise disparate and incompatible protectant compositions. Ingredients in the applied protectant chemistries in the '595 patent include those directed towards soil repellency, and water repellency. The method disclosed in the '595 patent is also resource-intensive, as the protectant chemistries described are applied at substantially acidic pH (e.g. pH 1.5). The effluent produced therefore requires considerable treatment.

In another instance, it has been disclosed that a water repellency attribute can be conferred to a synthetic yarn according to the method described in U.S. Pat. No. 8,057,693 ('693, to Ford). The method described in the '693 patent also requires application of disparate and otherwise incompatible protectant compositions for soil and water repellency on fibers and tufted carpets. The compositions and method in the '693 patent therefore lack the practicality typically required for application. Thus, there is a continuing need to develop convenient new ways to confer desirable attributes in an effective manner to synthetic yarns.

A distinctly different approach to improvement of synthetic yarn attributes entails using additives within synthetic yarn compositions at rates found to be effective for improving one or more desired performance characteristics. These additives are included in the polymer, for example as co-monomers and thus the improvement is said to be “built-in” to the fiber and should therefore require reduced protective chemistry treatment, or none at all. For example, the processes disclosed in PCT Publication no. 2012/092317 ('317, to Drysdale) entail polycondensation of fluorinated diaromatic species to yield polyarylene ester-based compositions that, upon fiber formation and carpet construction, impart enhanced water and oil repellency benefits to the finished carpet fiber. As a way to improve performance benefits of a finished fibrous article, the approach disclosed in the '317 patent is disadvantageous because it occurs so early in production of the ultimate product, i.e. carpet, modifications to all subsequent processing steps are very likely to be necessary, thus there is an undesirably large increase in overall complexity.

Poly(dihydrocarbylsiloxane)s have been used to an extent as additives in thermoplastics. EP Patent No. 220,576 B1, to Ohwaki et al ('576 patent), discloses a way to arrive at a polyester fiber having enhanced hydrophilicity through the use of polyether-modified polydimethylsiloxane oils. The polyether-modified polydimethylsiloxane oils are combined with polyester constituents in a polyesterification reaction vessel, with the intent that the polyether-modified polydimethylsiloxane oils are incorporated onto the polyester backbone prior to downstream polymer processing steps. This approach resulted in fiber constructs having enhanced hydrophilicity, as would be expected given the use of hydrophilic oxyethylene radicals present in the additives disclosed in the '576 patent.

EP Patent No. 1,569,985 B1, to Blackwood et al, ('985 patent) discloses compositions of siloxane-modified polyamides as additives for improving hydrophobicity in articles such as nylon fibers. Blackwood describes a commonly believed notion whereby polysiloxanes, or silicones, are not considered suitable thermoplastic melt additives because at typical thermoplastic processing temperatures the polysiloxane fluids have opportunity to migrate within the fiber and diminish fiber properties.

Reactive additives, such as those employed by Ohwaki and Blackwood, present the additional complication of increasing complexity in purifying and recycling the base thermoplastic matrix. In the case of Ohwaki, polyether-modified polysiloxane radicals become an intimate constituent of a polyester resin in a polyester recycling process. In the case of Blackwood, siloxane radicals become an intimate constituent of a polyamide. Innocuous poly(dihydrocarbylsiloxane)s are thus preferred as they do not involve intimately combined, or covalently bound, siloxane radicals in a thermoplastic recycling process.

U.S. Pat. No. 4,164,603, to Siggel et al, ('603 patent) discloses a process for forming polyester filaments using silicone oil and inert gas species where the silicone oil is understood to be comprised of one or both of dimethylsiloxy or diphenylsiloxy radicals. Silicones described in the '603 patent are said to aid in polymer extrusion as needle-shaped gaseous cavities form in the thermoplastic. Purely dimethylated and diphenylated siloxanes that assist in extrusion, inert gases and filaments bearing needle-shaped cavities formed by introduction of said gases are not part of the present disclosure.

U.S. Pat. No. 3,193,516, to Broatch et at ('516 patent), discloses a process for producing polyester filaments containing not more than 0.5% of an organopolysiloxane fluid. The organopolysiloxanes used are said to improve spinning performance by reducing the propensity for filaments to break. Siloxanes disclosed by Broatch as being useful include those having methyl, octyl, phenyl, gamma-trifluoro-propyl, gamma-cyanopropyl, tetrachlorophenyl, vinyl, and allyl groups. Dimethylpolysiloxanes are, however, disclosed as being preferred. That the organopolysiloxane fluids may be entirely linear or may have a small amount of cross-linking, for example, up to about ten percent of the silicon atoms may be cross-linked, is also disclosed in '516 patent to Broatch. Additionally the '516 patent states that the siloxanes employed may also be end-stopped if desired, for example, with trimethylsilyl groups. Autoclave additive and pellet tumbling methods are described as processes for achieving the desired combinations of polyester and organopolysiloxane.

U.S. Pat. No. 4,472,556, to Lipowitz and Kalinowski ('556 patent), discloses the employment of certain siloxane species for mechanical property improvements in a thermoplastic. Siloxane species described in the '556 patent feature various reactive chemical functionalities, including mercaptan, carboxylic acid, amine and ethylene oxide functionalities. Mechanical improvements noted include percent elongation, tensile strength and modulus, but it is conceivable, and even likely, that incorporation of such functionalized polysiloxanes into a thermoplastic base would be detrimental to other synthetic fiber performance criteria, such as dyeability, durability, and hydrophobicity, for example. In contrast, the polysiloxanes are innocuous as used in compositions disclosed herein.

U.S. Pat. No. 5,225,263, to Baravian et al ('263 patent), discloses a process for combining polydimethylsiloxane oils, having viscosities at room temperature of 350-2000 cSt, with thermoplastics such as poly(ethylene terephthalate) and polybutylene terephthalate). The '263 patent describes adding the polydimethylsiloxanes into the body or nozzle of an extruder using a metering pump for the purpose of forming nonwoven polyester fibers for backing support in tufted or stitched carpet constructions.

U.S. Pat. No. 5,759,685, to Baris and Fleury ('685 patent), discloses monofilaments useful for screen fabrics, and for paper-making machines. The monofilaments are prepared from modified polyesters such as modified polyethylene terephthalate. Such modification is made by introducing polydimethylsiloxanes during polycondensation processes. It is disclosed in the '685 patent that blocks of polydimethylsiloxane constituents are added into the base polyester polymer chain, which Applicants assert is undesirable for reasons given with regard to the '576 and '985 patents. Baris and Fleury further disclose that it is conceivable to feed in PDMS into a polyester melt in an extrusion operation, though this approach is given no elaboration, for reasons unknown.

PCT Publication No. 2002/16682, to Boyle, discloses polysiloxanes that are used as additives in polyamides and polyesters for the purpose of improving bulk behavior in carpets, by which it is meant that the additive polysiloxanes provide for reduced base polymer fiber weights, yet maintain their resistance to abrasive forces and coverage per given area. Boyle's preferred polydiorganosiloxane is an epoxidized polydimethylsiloxane, which is presumably employed for purpose of reacting with the base polymer end groups. For example, the amine end group of a polyamide base polymeric chain can react with an epoxy functional group to form a modified polyamide having a covalently bonded polydiorganosiloxane thereby attached. Reactive polydiorganosiloxanes are not included in the present disclosure, and are not preferred for reasons previously stated with respect to the '576 and '985 patents. Rather, innocuous poly(dihydrocarbylsiloxanes of the present disclosure are preferred.

### SUMMARY OF THE INVENTION

An alternative method of built-in fiber improvement is the use of additives that are unreactive and introduce little or no complexity to fiber and carpet production processes, as such the additives are considered innocuous, and yet they are found to impart certain desirable properties to a shaped article, such as carpet fiber including water repellency, soil release, softness. In this manner, innocuous additives are found to be surprisingly useful for improving the water repellency, dry soil repellency, and softness characteristics of synthetic yarns, and the tufted carpets produced therefrom.

An approach to improve soil release, water repellency, and softness of synthetic fibers has therefore been developed. The synthetic fibers are desirably made from polymer compositions having a substantial, i.e. greater than 85% by mass, thermoplastic component. Exemplary thermoplastic bases have one or more of a polyamide and a polyester. Specific examples of polyamides and polyesters found to be desirable are poly(hexamethylene adipamide), poly(hexamethylene sebacamide), poly(caprolactam), poly(11-aminoundecanoic acid), poly(12-aminododecanoic acid), poly(ethylene terephthalate), poly(trimethylene terephthalate), poly(butylene terephthalate), poly(ethylene naphthalate), poly(ethylene isophthalate), copolymers thereof, and mixtures thereof. Further, additives standard to the production of these polyamide and polyester resins may be used; such additives include virgin thermoplastics, recycled thermoplastics, colorants, delustrants, catalysts, spin assists, dye level modifiers, anti-microbial agents, stabilizers, flame-retardants, and anti-oxidants standard in the processing of these compositions. Still further, innocuous poly(dihydrocarbylsiloxane)s as described and used herein are found to work well within existing downstream processes while providing substantial and lasting benefit for finished tufted goods, including carpets.

There is a desire to reduce complexity in, for example, so-called secondary finish processes for carpet production whereby the need for such protectant treatments is diminished or obviated by improvements made to the fibers themselves. Further, there is a desire to reduce the energy and water resources used in these downstream secondary finish processes. Still further, there is a continuing demand for synthetic fibers with softer feel, or improved hand, as well as augmented water repellency and soil repellency. The present disclosure is directed to polymer compositions of thermoplastics having one or more innocuous poly(dihydrocarbylsiloxane) additives present. The synthetic fibers are desirably made from polymer compositions having a substantial, i.e. greater than 85% by mass, thermoplastic component. Exemplary thermoplastics have one or more of a polyamide and a polyester. Specific examples of polyamides and polyesters found to be desirable are poly(hexamethylene adipamide), poly(hexamethylene sebacamide), poly(caprolactam), poly(11-aminoundecanoic acid), poly(12-aminododecanoic acid), poly(ethylene terephthalate), poly(trimethylene terephthalate), poly(butylene terephthalate), poly(ethylene naphthalate), poly(ethylene isophthalate), copolymers thereof, and mixtures thereof. The product compositions are useful as synthetic fibers, in articles including carpet. An approach to improve soil repellency, water repellency, durability and softness of synthetic fibers has therefore been developed.

### DETAILED DESCRIPTION OF THE INVENTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, fiber, fabrics, textiles, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmosphere. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible. It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### DEFINITIONS

While mostly familiar to those versed in the art, the following definitions are provided in the interest of clarity.

As used herein, the terms “fiber” and “filament” refer to filamentous material that can be used in fabric and yarn as well as textile fabrication. Although in the art the term “filament” is often used to refer to fibers of extreme or indefinite length and the term “staple” is used to refer to a fiber of relatively short length, unless indicated otherwise in the surrounding text, the terms “fiber” and “filament” are used interchangeably in the present disclosure. One or more fibers can be used to produce a fabric or yarn. The yarn can be fully drawn or textured according to methods known in the art.

As used herein the term “yarn” refers to a continuous strand or bundle of fibers. Yarn is often used to make articles, such as carpets.

“Bulk” is the property of the yarn that most closely correlates to surface coverage ability of a given yarn.

As used herein, the terms “article” or “articles” includes, but are not limited to, fibers, yarns, films, carpets, apparel, furniture coverings, drapes, automotive seat covers, fishing nets, awnings, sail cloth, polyester tie-cord, hoist PET, military apparel, conveying belts, mining belts, water draining cloth, tarps (e.g., truck tarps), seat belts, harnesses, and the like. In particular, the article can be claimed as any one or combination of the articles noted above. In exemplary embodiments of the present disclosure, the article is carpet.

As used herein, the term “carpet” may refer to a structure including a primary backing having a yarn tufted through the primary backing. The underside of the primary backing can include one or more layers of material (e.g., coating layer, a secondary backing, and the like) to cover the backstitches of the yarn. In addition, the term “carpet” can include woven carpets without backing. In exemplary embodiments, the yarn used to form the carpet is made of bulked continuous filaments (BCFs), such as those of the present disclosure. Methods for making BCF yarns for carpets typically include the steps of twisting, heatsetting, tufting, dyeing and finishing.

As used herein the term “relative viscosity” (RV) refers to the viscosity property of a fiber-forming polymer which is the ratio of the viscosity of the polymer solution to the solvent viscosity.

dpf: denier per filament, where denier=weight in grams of a single fiber with a length of 9000 meters.

N6: nylon 6; polycaprolactam

N66: nylon 6,6; poly(hexamethylene adipamide)

OWF (On weight of fiber): The amount of solids that were applied after drying off the solvent.

WPU (Wet Pick-up): The amount of solution weight that was applied to the fiber before drying off the solvent.

Masterbatch: A solid product having pigments or other additives optimally dispersed therein, for example, in homogeneous fashion, for purpose of addition in a polymer processing step operation, for example by melting and extruding.

Innocuous: As used herein, the term “innocuous” is used to describe polysiloxane compositions that are non-reactive with the chemistry of the fiber.

Embodiments of the present disclosure are directed to thermoplastic synthetic polymer bulked continuous filaments (BCFs) having been formed with one or more poly(dihydrocarbylsiloxane) additives. The BCFs are produced such that they can have bulk and interlace. Similarly, the BCFs can have any cross section according to one or more desired properties including processability, aesthetics, bulk, and masking the presence of dirt.

The present disclosure also includes yarn formed from a plurality of such filaments which is rendered, among other things, extremely soft and water repellent, and is found to be especially useful as carpet yam where durably soft and water repellent attributes are desired, particularly as yarn for residential carpets. The present disclosure is also directed to articles, including, but not limited to, carpets, made from such yarns. Furthermore, the present disclosure also includes an apparatus for producing the compositions and filaments of the present disclosure. Still further, the present disclosure also includes the compositions which are prepared for the purpose of forming into such filaments.

Carpets made from polymer yarns, and particularly polyamide yarns such as nylon, are popular floor coverings for residential and commercial applications. Such carpets are relatively inexpensive and have a desirable combination of qualities, such as durability, aesthetics, comfort, safety, warmth, and quietness. Further, such carpets are available in a wide variety of colors, patterns, and textures. For residential carpets, pile height, fiber twist and tuft density can impact the feel, or softness, or hand of the carpet. Often, a topical treatment is applied to further augment a carpet's hand and soil resistance. Additionally, carpets made from polymer yarns have other properties, such as stain resistance, bulk, and durability.

The present invention is directed toward soft, water-repellent multifilament yarns and fabrics made therefrom, for use in carpeting and other demanding applications. The invention is further directed towards a process for manufacturing such yarns. Still further, the invention is directed towards an apparatus for manufacturing such yarns.

Polymer compositions suitable for use in the process and yarns of this disclosure, and which are capable of satisfying the requirements of carpets and other flooring applications, comprise melt spinnable polymers selected from the group consisting of polyamide and polyester homopolymers, copolymers, and mixtures thereof. Widely used polyamide and polyester polymers such as poly(hexamethylene adipamide), poly(hexamethylene sebacamide), poly(caprolactam), poly(11-aminoundecanoic acid), poly(12-aminododecanoic acid), poly(ethylene terephthalate), poly(trimethylene terephthalate), poly(butylene terephthalate), poly(ethylene naphthalate), poly(ethylene isophthalate), can be used.

The polymer compositions of the present disclosure have, as an additional component, poly(dihydrocarbylsiloxane)s that are either fluid or waxy in nature. The poly(dihydrocarbylsiloxane)s employed are nominally any polysiloxane bearing hydrocarbyl radicals, with particular emphasis given to dimethicone polymers bearing any alkyl length hydrocarbyl substituent. For example, the hydrocarbyl substituent can be octyl substituents, cetyl substituents, dodecyl substituents, behenyl substituents, vinyl substituents, bis-vinyl substituents, vinyl-reacted substituents, and bis-vinyl-reacted substituents as well as copolymers thereof and mixtures thereof. Where vinyl-reacted and bis-vinyl-reacted substituents are present as hydrocarbyl radicals, the polysiloxane employed is known to be crosslinked to a certain extent. A crosslinked polymer can be referred to as a crosspolymer. Thus, in certain embodiments of the present disclosure a poly(dihydrocarbylsiloxane) crosspolymer is employed.

The poly(dihydrocarbylsiloxane)s of the present disclosure are represented according to the chemical structures given by I or II:

(CH₃)₃—Si—O—[Si(CH₃)₂—O]ₙ—[Si(R₁)(R₂)—O]ₘ—[Si(R₃)(R₄)—O]ₚ—Si—(CH₃)₃, (I)

(R₁)(R₁)(R₂)—Si—O—[Si(CH₃)₂—O]ₘ—Si—(R₂)(R₃)(R₃), (II)

where R₁=C₂-C₃₂ saturated hydrocarbyl radical, vinyl radical, or ethenyl radical polymer crosslinking site,

R₂=C₁-C₃₂ saturated hydrocarbyl radical, vinyl radical, or ethenyl radical polymer crosslinking site,

R₃=C₂-C₃₂ saturated hydrocarbyl radical, vinyl radical, or ethenyl radical polymer crosslinking site and is not equal to R₁,

R₄ =C₁⁻C₃₂ saturated hydrocarbyl radical, vinyl radical, or ethenyl radical polymer crosslinking site and is not equal to R₂, n 0, m >0, and p 0.

As a first exemplary poly(dihydrocarbylsiloxane), a poly(dihydrocarbylsiloxane) that is a bis-vinyl, cetyl dimethicone crosspolymer is furnished by this disclosure. A bis-vinyl, cetyl dimethicone crosspolymer is available as SILWAX® CR-5016 (Siltech Corp) and is identified in the present disclosure as “AMP 1.” As a second exemplary poly(dihydrocarbylsiloxane), a poly(dihydrocarbylsiloxane) that is a bis-vinyl, behenyl dimethicone crosspolymer is furnished by this disclosure. A bis-vinyl, behenyl dimethicone crosspolymer is available as SILWAX® CR-5022 (Siltech Corp) and is identified in the present disclosure as “AMP 2.” As a third exemplary poly(dihydrocarbylsiloxane), a poly(dihydrocarbylsiloxane) that is an octyl dimethicone polymer is furnished by this disclosure. An octyl dimethicone polymer is available as SILWAX® CR 5008 (Siltech Corp) and is identified in the present disclosure as “AMP 3.”

In embodiments, the cross section of the filament of the present disclosure has domains of a poly(dihydrocarbylsiloxane) that can have diameters ranging from about 0.5 μm to about 5 μm in a plane perpendicular to the flow length of a discrete filament in the thermoplastic BCF. In further embodiments, the compounded pelletized blend of the present disclosure has domains of a poly(dihydrocarbylsiloxane) that can range from about 2 μm to about 30 μm in diameter. The multifilament yarns of the present disclosure, depending upon the specific end-use application, may be manufactured with linear densities in the range from about 30 to about 3000 denier, or from about 8 to 3000 denier. Soft, water-repellent yarns of this invention intended for use in the production of carpet may be manufactured with linear densities ranging from about 500 to about 12000 denier, including yarns having linear densities ranging from about 500 to about 1100 denier, and including yarns having linear densities ranging from about 1000 to about 8000, and including yarns having linear densities about 1600 to about 3000 denier. The discrete filaments are typically about 1 to about 40 dpf, or from about 4 to about 25 dpf, or from about 4 to about 18 dpf. Any reasonable denier may be used. A BCF having a cross section of any design known to those skilled in the art may be suitable in connection to the present disclosure. BCF cross sections for this purpose include trilobal, hexalobal, round, and rectangular cross sections. Additionally, the BCF cross sections can have one or more voids. Yarns can be formed from BCF types of one or more cross section varieties. Additionally, BCF yarns may have different cross sections in the same yarn bundle.

The poly(dihydrocarbylsiloxane)s described in the present disclosure are described as being innocuous as inclusion of said components, in a polymer composition does not require significant changes to processes involving spinning, processing, tufting, dyeing and finishing BCFs in any significant way. A filament in accordance with the present disclosure is a BCF prepared using a synthetic, thermoplastic melt-spinnable polymer or blend of thermoplastic polymers. Suitable polymers include polyamides and polyesters.

Further, a process for forming the polymer compositions noted above is disclosed wherein the thermoplastic is provided in pelletized form inside a container. An extruder having a feeding zone, and a barrel having one or more heated barrel zones and a screw is also necessary according to the present disclosure. The thermoplastic is dispensed from the container to the feeding zone of the extruder, and a poly(dihydrocarbylsiloxane) is then added. The combination of the thermoplastic and the poly(dihydrocarbylsiloxane) is then advanced through the heated barrel zones of the extruder to yield a molten extrudate.

In a first exemplary method, filaments are formed according to the process of the present disclosure by contacting a thermoplastic with a poly(dihydrocarbylsiloxane) at a location just prior to melting of the thermoplastic and mixing of the combination in an extruder. Following extrusion, the extrudate is then passed through a filter pack having porous media present, and is then passed through a spinneret plate having appropriately sized orifices therein, and then quenched with cross-flow air under conditions that vary depending upon the individual polymer, to produce a filament having the desired denier, exterior modification ratio, tip ratio, and void percentage. Commonly, air at 9° C. is used in a quench chimney at 300 cubic ft./rain, as disclosed by Tung in U.S. Pat. No. 5,380,592, which is incorporated by reference in its entirety. Void percentage can be increased by accelerating the quench step and increasing the melt viscosity of the thermoplastics in use, which can slow the attenuation from a non-round cross-section to a round cross section. Further, the effective quench rate can be adjusted for cross section control.

In a second exemplary method of forming filaments according to the present disclosure, a base thermoplastic is contacted with a poly(dihydrocarbylsiloxane) at a location where the base polymer has already been rendered molten, and mixing of the combination occurs in an extruder. Following extrusion, the thermoplastic blend is then passed through a filter pack having porous media present, and is then extruded through a spinneret plate having appropriately sized orifices therein, then quenched with cross-flow air under conditions that vary depending upon the individual polymer composition, to produce a filament or fiber having the desired denier, exterior modification ratio, tip ratio, and void percentage, as disclosed above.

In a third exemplary method of forming filaments according to the present disclosure, a poly(dihydrocarbylsiloxane) is incorporated into a thermoplastic polymer or blend of polymers as a masterbatch material in pellet form. A first thermoplastic is provided in pellet form, and the same or a second thermoplastic is provided having as an additive one or more innocuous poly(dihydrocarbylsiloxane)s. The poly(dihydrocarbylsiloxane) is thus present in the latter thermoplastic blend, The pelletized masterbatch material is used at a desired feed rate in combination with a base thermoplastic, desirably between 1 wt % and 25 wt % in the masterbatch. Mixing of the combination occurs in an extruder. Following extrusion, the polymer composition is then passed through a filter pack having porous media present, and is then passed through a spinneret plate having appropriately sized orifices therein, and then quenched with cross-flow air under conditions that vary depending upon the individual polymer, to produce a filament or fiber having the desired denier, as disclosed above.

Further, an apparatus for poly(dihydrocarbylsiloxane) fluid injection is disclosed wherein a programmable heating element, a thermocouple for measuring the temperature of the poly(dihydrocarbylsiloxane fluid, and a thermal feedback controller for controlling heat delivered by the heating element are provided. Also provided is an additive reservoir for housing the poly(dihydrocarbylsiloxane) fluid. The reservoir is suitable for containing a mixture of one or more poly(dihydrocarbylsiloxane)s. A balance is used for controlling the mass transfer of the poly(dihydrocarbylsiloxane)s from the reservoir, and a metering pump is used for the transfer of poly(dihydrocarbylsiloxane)s from the additive reservoir to an extruder. The metering pump can be any pump known to those skilled in the art, including a peristaltic pump, a screw pump, a progressive cavity pump, a pulser pump, a gear pump, a hand pump, a piston pump, a recessive spiral pump, a vacuum pump, and similar pumps.

In a first exemplary apparatus suitable according to the present disclosure, the continuous introduction of one or more poly(dihydrocarbylsiloxane)s into the feed zone or other zones of an extruder is accomplished by first providing a reservoir containing the poly(dihydrocarbylsiloxane)s. The reservoir is any container suitable for housing the additive, and it is adapted to conduct heat and provide stirring for the purpose of melting the additive and mixing any disparate phases of the additive, or for otherwise modifying its viscosity. Connected to the reservoir is tubing which allows for transport of the poly(dihydrocarbylsiloxane) to the feeding zone of an extruder, which is the point where the additive contacts the thermoplastic. A pump, as described above, is used to drive the transport of the additive from the reservoir to the feeding zone. The temperature at which the fluid material is transported is controlled, thus the heating element, which can be a hot plate, an oil bath, or band heater, is programmable for example by use of a thermocouple sensor and temperature control unit.

As disclosed above filaments or fibers, and yarns are provided for according to the present disclosure. In some embodiments, nylon fibers for the purpose of carpet manufacturing have linear densities of about 0.5 to 75 dpf. A more preferred range for carpet fibers is from about 3 to about 15 dpf.

In exemplary embodiments, the yarn of the present disclosure is drawn and texturized to form a BCF yarn suitable for tufting into carpets. One technique involves combining the extruded or as-spun fibers into a yarn, then drawing, texturizing and winding into a package all in a single step. This one-step method of making BCF yarn is generally known in the art as spin-draw-texturing (SDT).

The BCF yarns can go through various processing steps well known to those skilled in the art. For example, to produce carpets for floor covering applications, the BCF yarns are generally plied, twisted, heat set, and then tufted into a pliable primary backing. Primary backing materials are generally selected from woven jute, woven polypropylene, cellulosic nonwovens, and nonwovens of nylon, polyester and polypropylene. The primary backing can then be coated with a suitable material such as conventional styrene-butadiene (SB) latex, vinylidene chloride, ethylene vinyl acetate (EVA), or vinyl chloride-vinylidene chloride copolymers. It is common practice to use fillers such as calcium carbonate to reduce latex costs and provide dimensional stability. The final step is typically to apply a secondary backing, generally a woven jute or woven synthetic such as polypropylene. In embodiments, carpets for floor covering applications may include a woven polypropylene primary backing, a conventional SB latex formulation, and either a woven jute or woven polypropylene secondary carpet backing. The latex can include calcium carbonate filler, alumina trihydrate, clay, feldspar, zinc oxide, and potassium oleate.

While the discussion above has emphasized the fibers of this disclosure being formed into bulked continuous fibers for purposes of making carpet fibers, the fibers of this disclosure can be processed to form fibers for a variety of textile applications. In this regard, the fibers can be crimped or otherwise texturized and then chopped to form random lengths of staple fibers having individual fiber lengths varying from about 1.5 to 8 inches.

The fibers of the present disclosure can be dyed or colored utilizing conventional fiber-coloring techniques known to those of skill in the art. For example, the fibers of this disclosure may be subjected to an acid dye bath to achieve desired fiber coloration. Alternatively, the polymer may be colored in the melt prior to fiber-formation (e.g., solution dyed) using conventional pigments for such purpose.

Further, examples of other additives suitable for use according to the present disclosure are virgin thermoplastic, recycled thermoplastic, colorants, delustrants, catalysts, spin assists, dye level modifiers, anti-microbial agents, stabilizers, flame retardants, anti-oxidants and combinations thereof.

### Test Methods

Drum soiling is recorded as Delta E and measured according to ASTM D6540. Within the reproducibility limitations of this test, the relative soiling performance of variously-treated samples may be determined. The test simulates the soiling of carpet in residential or commercial environments to a traffic count level of about 100,000 to 300,000. According to ASTM D6540, soiling tests can be conducted on up to six carpet samples simultaneously using a drum. The base color of the sample (using the L, a, b color space) is measured using the hand held color measurement instrument sold by Minolta Corporation as “Chromameter” model CR-310. This measurement output is in the form L*, a* and b* values and describes a color value in color space. This is the original color value. The carpet sample is mounted on a thin plastic sheet and placed in the drum. Two hundred fifty grams (250 g) of dirty Zytel 101 nylon beads (by DuPont Canada, Mississauga, Ontario) are placed on the sample. The dirty beads are prepared by mixing ten grams (10 g) of AATCC TM-122 synthetic carpet soil (by Manufacturer Textile Innovators Corp. Windsor, N.C.) with one thousand grams (1000 g) of new Nylon Zytel 101 beads. One thousand grams (1000 g) of %-inch diameter steel ball bearings are added into the drum. The drum is run for 30 minutes with direction reversal every five minutes and the sample removed. After removal the carpet is cleaned with a vacuum cleaner and the chromameter is used again to measure the color of the carpet after cleaning. The difference between the color measurements of each carpet (before and after soiling and cleaning) is the total color difference, AE*, and is based on L*, a*, and b* color differences in color space, known to those skilled in the field where

ΔE*={square root over (((ΔL*)²*(Δa*)²*(Δb*)²))}

and Δ(ΔE*) is the difference between the total color difference of the control carpet before and after soiling and cleaning and the total color difference of a selected sample from the same drum before and after soiling and cleaning

Δ(ΔE*)=[{square root over (((ΔL*)²*(Δa*)²*(Δb*)²))}]_{in drum control}−[{square root over (((ΔL*)²*(Δa*)²*(Δb*)²))}]ₛₐₘₚₗₑ

This effectively provides for the normalization of the test samples to the in-drum control of each test drum thus allowing a reasonable comparison of color differences in carpets tested in multiple soiling drums. In the form of the equation above, if Δ(ΔE*)=0, the test carpet soiling performance matches that of the control carpet. If Δ(ΔE*)<0, the soiling performance of the test sample is worse than that of the control (i.e. the total color difference of the test sample after soiling and cleaning is larger than the same value for the control sample.) If Δ(ΔE*)>0, the soiling performance of the test sample is better than that of the control sample because the color of the test carpet after cleaning is closer to the original color measured before soiling ([ΔE*_{sample]} is less than [ΔE*_{in drum control}]).

Water Repellency

The following liquids were used for water repellency tests.

| | |
|---|---|
| Rating | Liquid composition |

| Number | % isopropanol | % water |
|---|---|---|
| 0 | 0 | 100 |
| 1 | 2 | 98 |
| 2 | 5 | 95 |
| 3 | 10 | 90 |
| 4 | 20 | 80 |
| 5 | 30 | 70 |
| 6 | 40 | 60 |

Water Repellency Test Procedure

Three to five drops of liquid corresponding to rating number N is placed from a height of 3 mm onto 5 locations on the carpet surface. If after 10 seconds, two out of three or four out of the five drops are still visible as spherical to hemispherical, the carpet is considered to have qualified for the current rating and the test is then repeated with the liquid of the next highest rating level. If less than the stipulated drops are visible as spherical to hemispherical after 10 seconds the carpet does not qualify for the current rating and is given the final repellency rating of the previous liquid composition, N−1, for which it was granted a passing result. If N=0 and the carpet does not qualify, the final rating is given as “FAIL”. Carpets with a rating of 3 or higher are considered to have good water repellency properties. Without water repellant treatment, most nylon carpets have a rating of 1 for water repellency.

Softness: No objective, standardized test method exists to characterize carpet handle. For the handle evaluations, a panel of raters is chosen where each panel member could differentiate between a sample known to be harsh and a sample known to be soft. They then compare carpet samples by touching them with the palm side of their hands, folding and unfolding their fingers, and pressing down on the carpet to detect differences in softness. Typically one or more samples are included of known-in-the-trade hand for reference. Preferably, identical base polymers, fiber type, and carpet construction are used since differences in these can significantly affect perceived hand softness. Panels may judge softness by either a forced ranking scale or an unforced binning method. In the latter case, score categories or bins are used such as “very soft,” “soft,” “neutral,” “harsh,” and “very harsh,” for example. The ratings of the samples by the panel are statistically evaluated to determine the handle and distinguishability of the samples.

Additional detailed description of some exemplary embodiments of the BCFs of the present disclosure and articles made with the filament of the present disclosure are described in the Examples below. However, the specific examples below are to be construed as merely illustrative, and not limitative of the remainder of the disclosure in any way whatsoever. Without further elaboration, it is believed that one skilled in the art can, based on the description herein, utilize the present disclosure to its fullest extent.

### EXAMPLES

Thermoplastics and thermoplastic blends used in the examples include one or more of polycaprolactam, poly(hexamethylene adipamide) and poly(ethylene terephthalate) bases having additives present known to those skilled in the art.

As an example, a quantity of AMP 3 was loaded into an additive reservoir and held at 50° C. A peristaltic pump equipped with tubing was used to transport AMP 3 at a constant rate from the additive reservoir to a twin screw extruder, at which point the AMP 3 contacted a quantity of pelletized poly(hexamethylene adipamide). The amount of AMP 3 delivered to the extruder was controlled by precalibrating the pump speed to the desired mass flow rate with a balance and a timer such that flow rate delivered to the extruder resulted in a product with 1.5 wt % AMP 3 for subsequent processing

The poly(hexamethylene adipamide)-AMP 3 polymer composition was extruded through spinnerets and divided into two (2) forty (40) filament segments. The molten fibers were then rapidly quenched in a chimney, where cooling air at a suitable temperature (about 9-25° C.) was blown past the filaments at about eighty cubic feet per minute [80 cfm] through the quench zone. The filaments were then coated with a lubricant for drawing and crimping. The coated yarns were drawn at 2380 yards per minute (2.6×draw ratio) using a pair of heated draw rolls. The draw roll temperature was one hundred sixty degrees Centigrade (160° C.). The filaments were then forwarded into a dual-impingement hot air bulking jet, similar to that described in Coon, U.S. Pat. No. 3,525,134, to form two 900 denier, 11.3 dpf BCF yarns. The temperature of the air in the bulking jet was 185° C. The spun, drawn, and crimped bulked continuous filament (BCF) yarns were two-ply cable-twisted to 5.75 turns per inch (tpi) on a cable twister and heat-set on a Suessen heat-setting machine at setting temperature of three hundred eighty three degrees Fahrenheit (383° F.; 195° C.). Depending on the fiber softness desired, the poly(dihydrocarbylsiloxane) is incorporated at between 0.5 wt % and 2.5 wt % in the final article.

The yarns were then tufted into 35 ounce per square yard, 22/32 inch pile height cut pile carpets on a 5/32 inch gauge (0.397 cm) cut pile tufting machine. The tufted carpets were dyed on a continuous range dyer into “light wool beige” color carpets.

In some instances the tufted carpets were treated with topical ingredients for additional performance benefit. For example, a product named S-815, made available by INVISTA™, was used on some nylon carpets. S-815 confers improved stain blocking ability into carpet fibers. As another example, a product named SL25, made available by Southern Clay Products, was used on some carpets. SL25 is an aqueous dispersion of siliceous nanoparticulate matter and dispersing aids.

In addition to carpet construction specifications known to those skilled in the art, the degree of softness, and water-repellency, that the carpets display upon construction from yarn is a function of the extent of poly(dihydrocarbylsiloxane) present in the polymer composition. Table 1 illustrates data measured for numerous N66 and N6 carpet samples. The data show the relationship between poly(dihydrocarbylsiloxane) use rate, and carpet softness, or hand, as well as water repellency. Table 2 illustrates data measured for numerous PET carpet samples. The data show the relationship between poly(dihydrocarbylsiloxane) use rate, and carpet softness, or hand.

TABLE 1
Table 1. Compiled data on test items relating to softness, water repellency, and soil release in N66
and N6. Softness and soil release values reported are averaged values. Sample X-1 was prepared by taking
carpet of FPW-1 and treating with S-815, which is a topical stainblocker available from INVISTA ™.

| | | | | | | | | Soil Release |
|---|---|---|---|---|---|---|---|---|
| | | | | | Softness | Softness | | (Δ(Δ E)) |
| | | wt % Additive | | | Panel 1 | Panel 2 | | positive = better |
| | Base | AMP | AMP | AMP | 1 = softest, | 1 = softest, | Water | than carpet control, |
| ID | Polymer | 1 | 2 | 3 | 7 = harshest | 10 = harshest | Repellency | negative = worse |
| FPW-1 | N66 | 0 | 0 | 0 | 5.6 | 7.7 | 0 | −3.58 |
| FPW-2 | N66 | 0.5 | — | — | 4.9 | — | 0 | −5.18 |
| FPW-3 | N66 | 1.5 | — | — | 5.5 | — | 0 | −2.48 |
| FPW-4 | N66 | — | 0.5 | — | 4.9 | — | 2 | −5.13 |
| FPW-5 | N66 | — | 1.5 | — | 2.8 | 3.3 | 3 | −4.97 |
| X-1 | N66 | — | — | — | — | — | 1 | 0 |
| untreated carpet | N66 | — | — | — | 3.1 | — | — | — |
| MAB-1 | N6 | 0 | 0 | 0 | — | 7.0 | 0 | −0.01 |
| MAB-2 | N6 | 0.5 | — | — | — | 5.9 | 0 | 0.76 |
| MAB-3 | N6 | 1.5 | — | — | — | 6.3 | 1 | −1.12 |
| MAB-4 | N6 | — | 0.5 | — | — | 5.8 | 2 | −2.46 |
| MAB-5 | N6 | — | 1.5 | — | — | 1.3 | 3 | −0.29 |
| MAB-6 | N6 | — | — | 0.5 | — | 6.6 | 1 | −3.27 |
| MAB-8 | N6 | 0.5 | 0.5 | — | — | 5.1 | 2 | 2.52 |
| MAB-9 | N6 | 0.5 | — | 0.5 | — | 6.0 | 0 | 1.96 |

TABLE 2
Table 2. Compiled data on test items relating to softness, water repellency, and soil release
in PET. Softness and soil release values reported are averaged values. All samples having
been topically treated have been so treated such that 0.1 wt % owf of a siliceous nanoparticle
product named SL25, available from Southern Clay Products, has been applied.

| | | | | | | Softness | Water Repel- | |
|---|---|---|---|---|---|---|---|---|
| | | | wt % Additive | | | Rating | lency Rating | (Δ(Δ E)) |
| | Topically | Base | AMP | AMP | AMP | 1 = softest, | 0 = fail, | less than 100% = |
| Yarn ID | Treated? | Polymer | 1 | 2 | 3 | 13 = harshest | 3 or more = good | better than control |
| 104-01 | no | PET | | | | | | 100.0 |
| 104-01 | yes | PET | | | | 6.7 | 2 | 95.3 |
| 104-02 | yes | PET | 1 | | | 8.4 | 3 | 100.2 |
| 104-03 | yes | PET | | 1.5 | | 6.2 | 2 | 104.0 |
| 104-03 | no | PET | | 1.5 | | | 2 | |
| 104-04 | yes | PET | | | 1 | 8.4 | 2 | 89.2 |
| 104-05 | yes | PET | 0.5 | 0.75 | 0.5 | 5.4 | 1 | 79.5 |
| 104-05 | no | PET | 0.5 | 0.75 | 0.5 | | 2 | |
| 104-06 | yes | PET | 1 | 1.5 | | 6.7 | 1 | 86.2 |
| 104-06 | no | PET | 1 | 1.5 | | | 3 | |
| 104-07 | yes | PET | 1 | | 1 | 7.5 | 1 | 91.6 |
| 104-07 | no | PET | 1 | | 1 | | 2 | |
| 104-08 | yes | PET | | 1.5 | 1 | 6.6 | 2 | 81.2 |
| 104-08 | no | PET | | 1.5 | 1 | | 3 | |
| 104-09 | yes | PET | 0.75 | 1.125 | 0.75 | 3.3 | 2 | 100.7 |
| 104-09 | no | PET | 0.75 | 1.125 | 0.75 | | 2 | |
| 104-10 | yes | PET | 0.5 | | 0.5 | 7.2 | 2 | 109.5 |
| 104-13 | yes | PET | 0.5 | 0.75 | | 10.7 | 2 | 98.0 |
| 104-14 | yes | PET | 0.5 | 0.5 | | 5.8 | 1 | 106.8 |
| 104-14 | no | PET | 0.5 | 0.5 | | | 2 | |
| 104-15 | yes | PET | | 0.75 | 0.5 | 7.6 | 2 | 112.1 |

The finished carpets were examined by a panel of carpet researchers for softness assessment. The results are summarized below.

| | \|Softest\| \|Harshest\| |
|---|---|
| N66 Softness: | |
| | FPW-5 → untreated N66 → FPW2, |
| | FPW-4 → FPW-3 → FPW-1 |
| Softness (all): | |
| | MAB-5 → FPW-5 → MAB-8 → MAB-4 → |
| | MAB-2 → MAB-9 → |
| | MAB-3 → MAB-6 → MAB-1 → (N6 base) → FPW-1 |
| | (N66 base) |

A selection of the carpet samples made with the inventive BCF of the present disclosure were judged to have varying degrees of softness relative to the softness of untreated N66 and N6 carpets. Thus, this demonstrates that the BCF fibers of the present disclosure and the polymer compositions used for making the BCF fibers of the present disclosure provide significant advantages over known BCF fibers and their corresponding polymer compositions. This attribute is found to be particularly advantageous for carpet applications, and, more particularly, tufted, backed carpets having high pile height where the carpet pile must remain soft, durable, soil resistant and water repellent. Notably, since carpets of the present disclosure provide benefits of water repellency and soil release, where fluorochemicals or fluorochemical mixtures are topically applied, the innocuous poly(dihydrocarbylsiloxane)s of the present disclosure act to reduce or eliminate the application of topical treatments in a carpet mill.

While there have been described what are presently believed to be the preferred embodiments of the invention, those skilled in the art will realize that changes and modifications may be made thereto without departing from the spirit of the invention, and it is intended to include all such changes and modifications as fall within the true scope of the invention.

1. A polymer composition comprising:
a thermoplastic, and
one or more poly(dihydrocarbylsiloxane)s,
wherein said thermoplastic includes at least one polymer selected from the group consisting of:
poly(hexamethylene adipamide),
poly(hexamethylene sebacamide),
poly(caprolactam),
poly(11-aminoundecanoic acid),
poly(12-aminododecanoic acid),
poly(ethylene terephthalate),
poly(trimethylene terephthalate),
polybutylene terephthalate),
poly(ethylene naphthalate),
poly(ethylene isophthalate),
copolymers thereof, and mixtures thereof,
and wherein said poly(dihydrocarbylsiloxane) is represented according to the chemical formula given by I or II:
(CH₃)₃—Si—O—[Si(CH₃)₂—O]ₙ—[Si(R₁)(R₂)—O]ₘ—[Si(R₃)(R₄)—)]ₚ—Si—(CH₃)₃, (I)
(R₁(R₁)(R₂)—Si-—O—[Si(Ch₃)₂—O]ₘ—Si—(R₂(R₃)(R₃), (II)
where R₁=C₂-C₃₂ saturated hydrocarbyl radical, vinyl radical, or ethenyl radical polymer crosslinking site,
R₂=C₁-C₃₂ saturated hydrocarbyl radical, vinyl radical, or ethenyl radical polymer crosslinking site,
R₃=C₂-C₃₂ saturated hydrocarbyl radical, vinyl radical, or ethenyl radical polymer crosslinking site and is not equal to R₁,
R₄=C₁-C₃₂ saturated hydrocarbyl radical, vinyl radical, or ethenyl radical polymer crosslinking site and is not equal to R₂,
n≧0,
m>0,
and p≧0.

2. The polymer composition of claim 1, wherein said thermoplastic includes about 85 wt. % to about 95 wt. % poly(hexamethylene adipamide), and about 4.5 wt. % to about 13.5 wt. % poly(caprolactam) based on the total weight of the polymer composition.

3. The polymer composition of claim 1, wherein said thermoplastic includes about 85 wt. % to about 95 wt. % poly(hexamethylene adipamide), and about 4.5 wt. % to about 13.5 wt. % poly(ethylene terephthalate), based on the total weight of the polymer composition.

4. The polymer composition of claim 1, wherein said thermoplastic includes about 88 wt. % to about 99.5 wt. % poly(ethylene terephthalate).

5. The polymer composition of claim 1, wherein said thermoplastic includes about 88 wt. % to about 99.5 wt. % poly(caprolactam) based on the total weight of the polymer composition.

6. The polymer composition of claim 1, wherein said thermoplastic includes about 88 wt. % to about 99.5 wt. % poly(hexamethylene adipamide) based on the total weight of the polymer composition.

7. The polymer composition of claim 1, wherein said poly(dihydrocarbylsiloxane)s are vinyl-reacted poly(dihydrocarbylsiloxane) crosspolymers.

8. The polymer composition of claim 1 wherein said poly(dihydrocarbylsiloxane)s are present from about 0.5 wt. % to about 2.5 wt. % based on the total weight of the polymer composition.

9. The polymer composition of claim 1 wherein said poly(dihydrocarbylsiloxane)s are present from about 0.5 wt. % to about 5.0 wt. % based on the total weight of the polymer composition.

10. The polymer composition of claim 1, further comprising a component selected from the group consisting of: virgin thermoplastic, recycled thermoplastic, colorants, delustrants, catalysts, spin assists, dye level modifiers, anti-microbial agents, stabilizers, flame-retardants, anti-oxidants, acidic moieties conducive to cationic dyeing, and combinations thereof.

11. A process for forming the polymer composition of claim 1 comprising:
a. providing said thermoplastic in pelletized form inside a container,
b. providing an extruder comprising a feeding zone, a barrel having one or more heated barrel zones and one or more screws in close proximity to said container,
c. dispensing said thermoplastic from the container to the feeding zone of said extruder,
d. adding said poly(dihydrocarbylsiloxane),
e. advancing said thermoplastic and said poly(dihydrocarbylsiloxane) through the heated barrel zones of said extruder to yield a molten extrudate.

12. The process of claim 11, wherein said extruder has two screws.

13. The process of claim 11, wherein said barrel has one or more injection ports disposed across one or more of said heated or unheated barrel zones.

14. The process of claim 13, wherein the poly(dihydrocarbylsiloxane) is injected through said one or more injection ports.

15. The process of claim 11, wherein the poly(dihydrocarbylsiloxane) is added as a masterbatch at a use rate between about 1 wt % and about 25 wt %, based on the total weight of the polymer composition.

16. The process of claim 11, wherein the poly(dihydrocarbylsiloxane) is added at the feeding zone.

17. The process of claim 11, further comprising the steps of:
a. directing said extrudate through a dye upon exiting the extruder to form a noodle in a molten state,
b. directing said noodle into a trough filled with water to form a noodle in a cooled state,
c. and chopping said noodle into pelletized form.

18. The process of claim 11, further comprising:
a. passing said extrudate exiting said extruder through a pack filter,
b. passing said extrudate exiting said pack filter through a spinneret to form one or more continuous filaments,
c. converging said filaments to render a fiber.

19. The process of claim 18, further comprising the steps of spinning, drawing and optionally bulk-texturizing said fiber to form a yarn.

20. The process of claim 19 further comprising dyeing said yarn with one or more dyes.

21. The process of claim 20 wherein the dye or dyes are acid dyes.

22. The process of claim 20 wherein the dye or dyes are disperse dyes.

23. The process of claim 20 wherein the dye or dyes are cationic dyes.

24. The fiber formed by the process of claim 18.

25. The fiber of claim 24, wherein said fiber has a linear density of 0.5 to 75 denier per filament.

26. The fiber of claim 25, wherein said fiber has a linear density of 4 to 25 denier per filament.

27. The yarn formed by the process of claim 19.

28. The yarn of claim 27, wherein said yarn has a linear density from about 500 to about 12000 denier.

29. The yarn of claim 28, wherein said yarn has a linear density from about 500 to about 1100 denier.

30. An apparatus for poly(dihydrocarbyisiloxane) fluid injection comprising:
a. a programmable heating element,
b. a thermocouple for measuring the temperature of said fluid
c. a thermal feedback controller for controlling heat delivered by said heating element,
d. an additive reservoir for housing said poly(dihydrocarbylsiloxane)s, further comprising one or more poly(dihydrocarbylsiloxane)s,
e. a balance for controlling mass of said poly(dihydrocarbylsiloxane)s,
f. and a metering pump for accomplishing the transfer of poly(dihydrocarbylsiloxane)s from the additive reservoir to said extruder.

31. The apparatus of claim 30, adapted for use according to the method of claim 11.

32. The apparatus of claim 30, wherein the metering pump is a peristaltic pump, a screw pump, a progressive cavity pump, a pulser pump, a gear pump, a hand pump, a piston pump, a recessive spiral pump, or a vacuum pump.

33. A tufted carpet made from the yarn of claim 27.

34. The tufted carpet of claim 33, wherein said carpet is dyed with one or more acid, disperse or cationic dyes.

35. The tufted carpet of claim 33, wherein said carpet is treated with topical protectants selected from the list consisting of stain blocking agents, soil repellency agents, water repellency agents, flame retardants, bactericides, or fungicides.

36. The apparatus of claim 30, adapted for use according to the method of claim 16.
